(19) United States
(12) Patent Application Publication
(10) Pub. No.: US 2025/0155638 A1
(43) Pub. Date: May 15, 2025

(54) III-NITRIDE-BASED FERROELECTRIC PHOTONIC DEVICES

(71) Applicant: The Regents of the University of Michigan, Ann Arbor, MI (US)

(72) Inventors: Jiangnan Liu, Ann Arbor, MI (US); Zetian Mi, Ann Arbor, MI (US)

(21) Appl. No.: 18/946,333

(22) Filed: Nov. 13, 2024

Related U.S. Application Data
(60) Provisional application No. 63/598,259, filed on Nov. 13, 2023.

(51) Int. Cl. G02B 6/125; G02B 6/12; G02B 6/136

(52) U.S. Cl. CPC G02B 6/125; G02B 6/136; G02B 2006/1208; G02B 2006/12142

(57) ABSTRACT

A photonic device includes a substrate and a waveguide supported by the substrate. The waveguide includes a III-nitride-based layer. The III-nitride-based layer is ferroelectric.

### CROSS-REFERENCE TO RELATED APPLICATION

This application claims the benefit of U.S. provisional application entitled “III-Nitride-Based Ferroelectric Photonic Devices,” filed Nov. 13, 2023, and assigned Ser. No. 63/598,259, the entire disclosure of which is hereby expressly incorporated by reference.

### BACKGROUND OF THE DISCLOSURE

### Field of the Disclosure

The disclosure relates generally to photonic devices.

### Brief Description of Related Technology

Silicon photonic devices have been extensively studied. But silicon has a small indirect bandgap, which limits its applications as, for instance, efficient light sources. The centrosymmetric crystalline structure of silicon also suppress second-order nonlinearity.

Lithium niobate (LiNbO₃) has gained more attention in recent years due to the large optical x⁽²⁾ nonlinearity. But LiNbO₃ has been challenging in micro-processing, such as dry etching, thickness control, and integration.

Although significant progress has been made in SiNₓ and LiNbO₃ based photonic devices, these platforms have prohibitively high loss in the UV and blue spectrum and do not directly support optoelectronic and electronic functionalities.

Aluminum nitride is a wide bandgap (about 6.1 eV) semiconductor, which is transparent from deep ultraviolet (UV) to infrared wavelengths, providing a potentially ultralow-loss optical platform. Several applications, such as high-Q microring resonators, frequency combs, and electro-optical modulators, have been demonstrated on an AlN platform with great performance. However, while the wurtzite noncentrosymmetric structure of AlN provides the devices with second-order optical nonlinearity, its performance parameters are lower than other nonlinear materials such as LiNbO₃.

### SUMMARY OF THE DISCLOSURE

In accordance with one aspect of the disclosure, a photonic device includes a substrate, and a waveguide supported by the substrate. The waveguide includes a III-nitride-based layer. The III-nitride-based layer is ferroelectric.

In accordance with another aspect of the disclosure, a photonic device includes a substrate and a heterostructure supported by the substrate. The heterostructure includes a III-nitride-based waveguide. The III-nitride-based waveguide includes a ferroelectric layer.

In accordance with yet another aspect of the disclosure, a microring resonator device includes a substrate, a bus waveguide supported by the substrate, and a ring waveguide supported by the substrate and spaced from the bus waveguide. The ring waveguide includes a III-nitride-based layer. The III-nitride-based layer is ferroelectric.

In connection with any one of the aforementioned aspects, the devices described herein may alternatively or additionally include or involve any combination of one or more of the following aspects or features. The III-nitride-based layer is single-crystalline. The waveguide includes a buffer layer disposed between the III-nitride-based layer and the substrate. The buffer layer includes a III-nitride-based material. The III-nitride-based material is AlN. The waveguide is configured as a resonator. The waveguide is configured as a ring resonator. The waveguide is configured as a bus waveguide. The waveguide is configured for second harmonic generation. The III-nitride-based layer includes ScAlN. The photonic device further includes an electrode spaced from the waveguide to apply an electric field to the waveguide. The substrate includes sapphire. The ferroelectric layer is single-crystalline. The heterostructure further includes a buffer layer disposed between the ferroelectric layer and the substrate. The buffer layer includes a III-nitride-based material. The III-nitride-based material is AlN. The III-nitride-based waveguide is configured as a resonator. The III-nitride-based waveguide is configured as a ring resonator. The III-nitride-based waveguide is configured as a bus waveguide. The III-nitride-based waveguide is configured for second harmonic generation. The ferroelectric layer includes ScAlN. The photonic device further includes an electrode spaced from the III-nitride-based waveguide to apply an electric field to the III-nitride-based waveguide. The III-nitride-based layer is single-crystalline.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts (a) an atomic force microscope image and (b) x-ray diffraction spectrum of an example Sc_{0.2}Al_{0.8}N layer grown on AlN template and sapphire substrate, as well as (c) P-E and I-E hysteresis loops exhibited by a capacitor having a Sc_{0.2}Al_{0.8}N layer disposed in a heterostructure of Au/Ti/Sc_{0.2}Al_{0.8}N/GaN.

FIG. 2 depicts (a) a schematic view of a photonic device having a ring resonator pulley-coupled to an external waveguide in accordance with one example, (b) an SEM image of a fabricated example of the photonic device after ScAlN etching, (c) an enlarged SEM image showing the sidewall after ScAlN etching, (d) a graphical plot of the transmission spectrum of an example of the photonic device having a ring radius of 100 μm, a ring width of 2.5 μm, and a gap between the ring and the waveguide of 400 nm, and (e) a graphical plot of the resonance peak near 1500 nm.

FIG. 3 depicts (a, b) schematic illustrations of microring resonator modulators (MRMs) and a magnified ring resonator in accordance with one example, as well as (c) a cross-section of an MRM device in accordance with one example.

FIG. 4 depicts experimental data of SHG polarimetry of example ScAlN films with different Sc doping levels.

FIG. 5 depicts SEM images of (a) an example ScAlN film and (b) a sidewall of a microring resonator (MRR) device having a ferroelectric ScAlN layer in accordance with one example.

FIG. 6 depicts (a) an optical microscope image of an example MRR device having a ferroelectric ScAlN layer, (b) a graphical plot of the transmission spectrum of the ScAlN-based MRR device, and (c) a graphical plot of a single resonant peak of measured (black line) and fitted (red line) data.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Photonic devices having a III-nitride-based ferroelectric waveguide are described. In some cases, the III-nitride-based ferroelectric waveguides of the disclosed devices are configured to implement a microring resonator and/or a microring resonator modulator.

The incorporation of scandium (Sc) can transform AlN to be ferroelectric. The resulting ferroelectric ScAlN exhibits significantly enhanced electrical, piezoelectric, as well as linear and nonlinear optical properties. For example, the piezoelectric coefficient d₃₃ and permittivity of Sc_{0.4}Al_{0.6}N are nearly five and two times larger than that of AlN, respectively. ScAlN also possesses unusually large optical x⁽²⁾ nonlinearity, which has been measured to be at least one order of magnitude higher than AlN and twice the value of the extensively studied LiNbO₃. These unique characteristics, together with its ultrawide bandgap, ferroelectric functionality, and seamless integration with III-nitride technology, have made ScAlN a very promising platform for future integrated quantum photonics.

Sputter-deposition has been commonly used for the growth of ScAlN films. However, the resulting ScAlN films exhibit very limited material quality, leading to non-optimal device performance. In contrast, the disclosed devices are based on epitaxial grown, single-crystalline ferroelectric ScAlN. As described herein, epitaxial ScAlN grown via, for instance, molecular beam epitaxy (MBE), supports the formation of ScAlN waveguides and ring resonators, which offer, for the first time, the ability to truly unlock the potential of this material system.

The III-nitride-based waveguides of the disclosed devices may exhibit wide range of optical transparency from ultraviolet (UV) to mid-infrared (IR) wavelengths. The III-nitride-based platform enables active and passive PIC components with high power handling properties and second-and third-order nonlinear optical properties. These features allow a variety of linear and nonlinear PIC devices operating over a broad range of wavelengths to be realized. For instance, various PIC devices may be realized, including, for instance, high-Q resonators, electro-optic (EO) modulators, on-chip frequency comb, and devices exhibiting generation of second or third harmonics.

Although described in connection with heterostructures having one or more structures or layers composed of, or otherwise including, ScAlN, the composition and/or other characteristics of the heterostructures of the disclosed devices may vary. Other III-nitride alloys or III-nitride-based materials may be used. The composition of the waveguides of the disclosed devices may thus vary from the examples described herein. The disclosed devices are therefore not limited to layers composed of III-nitride alloys including scandium. For instance, the III-nitride-based ferroelectric layers may include additional or alternative group IIIB elements, such as yttrium (Y) and lanthanum (La).

Further details regarding non-ferroelectric components, structures, and/or other aspects of the disclosed photonic devices may be found in Sun et al., “Ultrahigh Q microring resonators using a single crystal aluminum-nitride-on-sapphire platform,” Optics Letters, Vol. 44, No. 23, pp. 5679-5681 (2019), and Shin et al., “Demonstration of green and UV wavelength high Q aluminum nitride on sapphire microring resonators integrated with microheaters,” Appl. Phys. Lett. 118, 211103 (2021), the entire disclosures of which are hereby incorporated by reference.

Although described in connection with microring resonator (MRR) and microring resonator modulator (MRM) devices, the disclosed heterostructures and devices may be incorporated into to a wide variety of photonic devices. For instance, the heterostructures may be configured as, or otherwise include, non-ring shaped resonator structures, such as photonic crystal structures. The disclosed heterostructures and devices may also be configured for photonic functions other than modulation.

Although described in connection with examples having a buffer layer composed of AlN, the buffer layer of the disclosed devices may include alternative or additional III-nitride semiconductor buffer, template, base, or other layers. For instance, the buffer layer may be composed of, or otherwise include, GaN. Additional or alternative types of materials may also be used in the heterostructures, including, for instance, other semiconductor materials. For instance, other nitride semiconductors, such as II-IV-Nitrides (e.g., ZnGeN₂, ZnSiN₂, ZnMgN₂, and related alloys), may be used as a buffer or other layer. In such cases, the composition of the ferroelectric layer may vary accordingly.

Although described in connection with examples having a sapphire substrate, alternative or additional substrate materials may be used. For instance, the substrates of the disclosed devices may be composed of, or otherwise include, Ga₂O₃, SiOₓ, Si, SiNₓ, Al, and Mo.

Further details on the epitaxial growth conditions, procedures, and related parameters that may be used to form the III-nitride-based ferroelectric layer described herein are set forth in WO 2023/022768 (“Epitaxial Nitride Ferroelectronics”), International Application No. PCT/US23/13727 (“Epitaxial Nitride Ferroelectronic Devices” filed Feb. 23, 2023), P. Wang, et al., “Fully epitaxial ferroelectric ScAlN grown by molecular beam epitaxy,” Applied Physics Letters, vol. 118, p. 223504 (2021), D. Wang et al., “An Epitaxial Ferroelectric ScAlN/GaN Heterostructure Memory,” Advanced Electronic Materials, p. 2200005 (2022), D. Wang, et al., “Fully epitaxial ferroelectric ScGaN grown on GaN by molecular beam epitaxy,” Appl Phys Lett 119 (11), 111902 (2021), D. Wang et al., “Impact of dislocation density on the ferroelectric properties of ScAlN grown by molecular beam epitaxy,” Appl Phys Lett 121 (4), 042108 (2022), and P. Wang et al., “Quaternary alloy ScAlGaN: A promising strategy to improve the quality of ScAlN,” Appl Phys Lett 120 (1), 012104 (2022), the entire disclosures of which are hereby incorporated by reference.

Although the disclosed methods are described in connection with MBE growth procedures, additional or alternative non-sputtered epitaxial growth procedures may be used. For instance, metal-organic chemical vapor deposition (MOCVD), hydride vapor phase epitaxy (HVPE), atomic layer deposition (ALD), and atomic layer epitaxy (ALE) growth procedures may be used. Still other procedures may be used, including, for instance, pulsed laser deposition procedures.

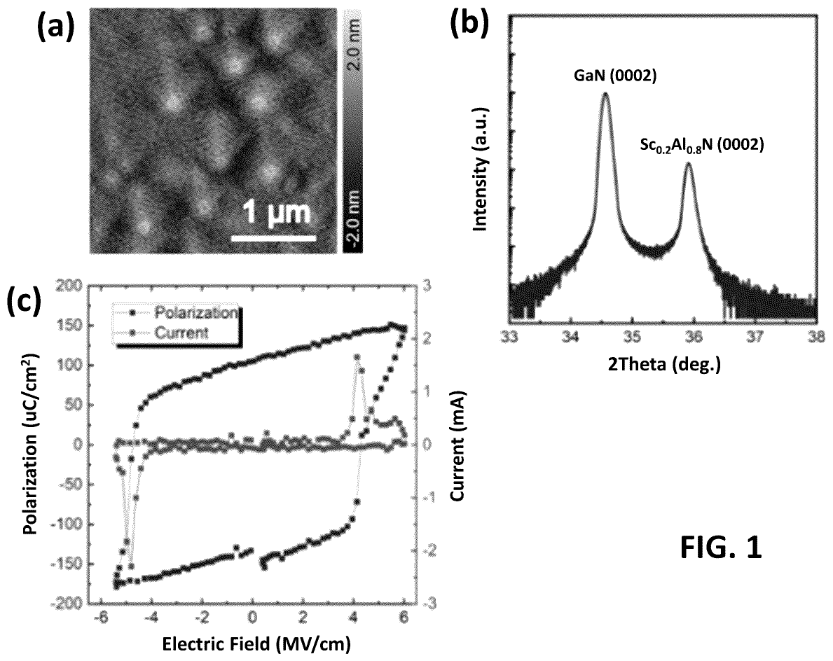

An example of a high quality, single crystalline ferroelectric ScAlN layer was grown by plasma-assisted MBE, in which the Sc content may be tuned by the Sc/Al beam flux ratio during the growth. FIG. 1, parts (a) and (b), show atomic force microscopy (AFM) and X-ray diffraction (XRD) characterizations of the Sc_{0.2}Al_{0.8}N layer grown on a GaN template. FIG. 1, part (c), illustrates P-E and I-E loops measured on metal/ferroelectric/semiconductor capacitor structures, showing unambiguous evidence for ferroelectric switching. The ferroelectric switching of the single crystalline ScAlN layer was further confirmed as robust. Moreover, the energy bandgap of the single crystalline ScAlN layer may be tuned in a large part of the UV spectrum by varying the Sc composition.

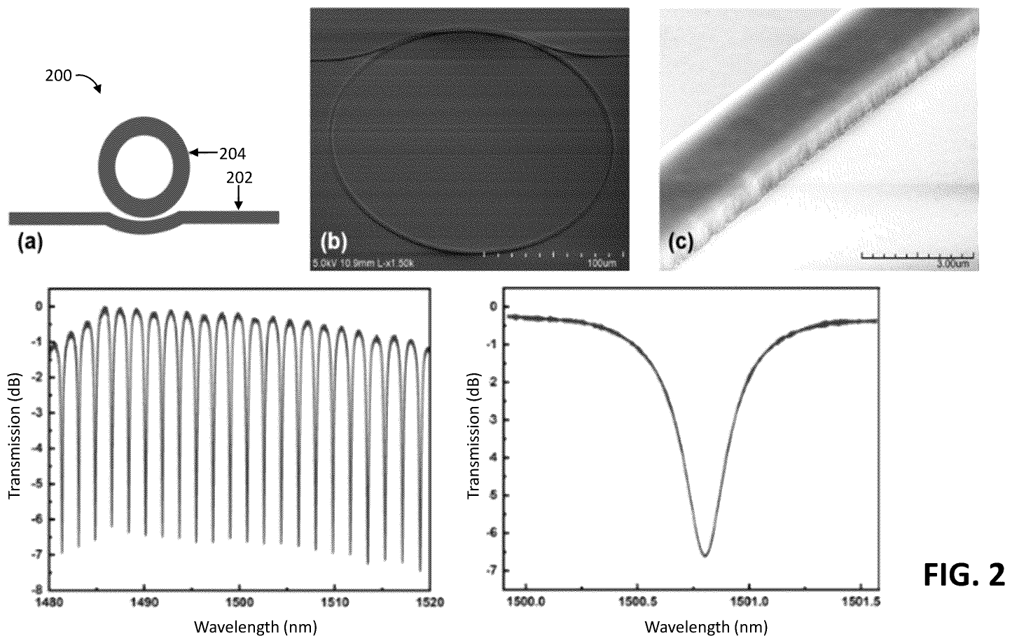

With reference to FIG. 2, examples of ScAlN-based microring resonator devices 200 were fabricated. The example microring resonator devices 200 had a configuration with a ring radius of 100 μm and ring widths varying between 2.5 μm and 3 μm. The widths of the gap between a waveguide 202 and a resonator 204 range from 300 to 400 nm. Each of the example microring resonator devices 200 had a pulley-coupling configuration or structure, as illustrated in FIG. 2, part (a). The pulley-coupling configuration may be used to enhance the interaction length between the waveguide 202 and the resonator 204.

The fabrication of the example ScAlN-based microring resonator devices was based on epitaxial growth of high quality ScAlN on a sapphire substrate. A 30-nm-thick AlN was initially grown on the sapphire substrate as a buffer layer, followed by 500-nm-thick Sc_{0.2}Al_{0.8}N on top by MBE. The grown sample was then fabricated into the device by utilizing double hard etching masks. Further details regarding the etching and other aspects of the fabrication process are set forth in the above-referenced publication on AlN-based microring resonators. In this example, 500-nm-thick SiO₂ was deposited by PECVD as the first etching mask. Then, the second hard mask, which reflects the structure of the microring resonators and the external waveguides, was defined by E-beam lithography and a 30-nm-thick Al₂O₃ deposition followed by the lift-off process. SiO₂ and ScAlN layers were subsequently etched under fluorine and chlorine-based chemistry respectively in a reactive ion etching (RIE) system. The etching process proceeds until the sapphire substrate. The device structure and its sidewall are shown in FIG. 2, parts (b) and (c). The remaining hardmask was then removed in buffered oxide etchant (BOE) and a 3-μm-thick SiO₂ layer was deposited by PECVD as a cladding layer on top.

A chip having the example ScAlN-based microring resonator device was diced and polished on the edge facets for edge coupling. Transmission measurements around 1500 nm were then performed. The transmission spectrum of a device with a gap of 400 nm, ring radius of 100 μm and width of 2.5 μm is shown in FIG. 2, part (d). A zoomed view of the peak near 1500 nm shown in FIG. 2, part (e), was used to do fittings and the intrinsic quality factor was extracted to be 5.8×10³. Improvements to the Q factor may be realized via optimization or other updates to the growth and fabrication process.

Examples of microring resonators having a ferroelectric ScAlN layer epitaxially grown on sapphire substrates have been successfully demonstrated. The high nonlinearity, ultrawide bandgap, robust ferroelectricity and seamless integration of the ScAlN layer may be combined with III-nitride based optoelectronic and electronic device technology to realize a variety of integrated photonic and quantum photonic devices.

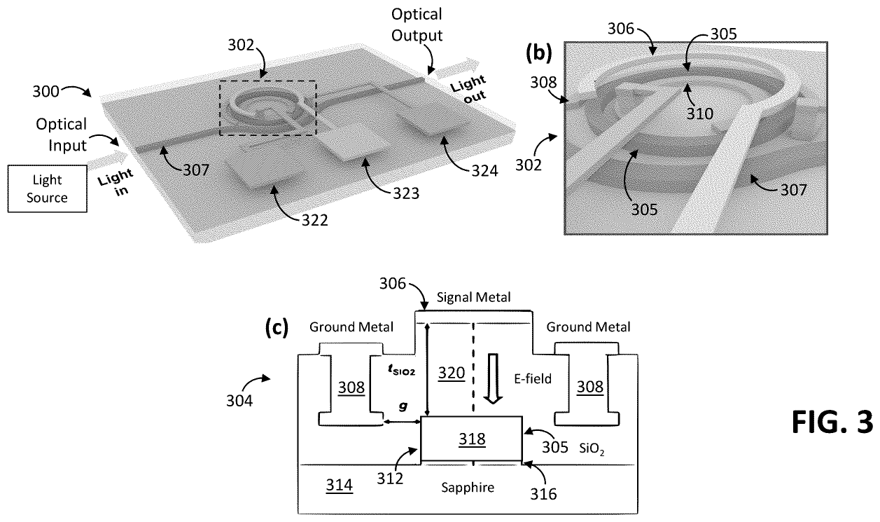

FIG. 3 depicts a photonic device 300 having a ferroelectric ScAlN layer in accordance with one example. The photonic device 300 may be configured as, or include, a microring modulator device (MRM). The photonic device 300 may include a microring resonator as described above and/or a different microring resonator.

FIG. 3, parts a and b, schematically show an MRM device 300 having a ring resonator 302 in accordance with one example. The ring resonator 302 includes a heterostructure as described herein. FIG. 3, part c, shows the cross-sections of an example ring resonator 304. The ring resonator 302 of the device 300 may be configured in accordance with the example resonator 304 shown in FIG. 3, part c. Features in common between the examples are accordingly labeled with common reference numerals.

In the examples shown in FIG. 3, ground metal electrodes or structures 308, 310 are disposed on or along the lateral sides of a core 305 (or waveguide core, or waveguide) of the ring resonator 304, and a signal metal electrode or structure 306 is placed on top of the ring resonator 304 above the core 305, which may be wider than a bus waveguide 307 of the MRM device 300 to provide a uniform electric field in the waveguide.

As described herein, each waveguide core 305 includes a heterostructure 312 supported by a substrate 314 (e.g., sapphire substrate). Each heterostructure 312, in turn, includes a base (or buffer) layer 316 and a ferroelectric layer 318 supported by the base layer 316. In this example, the ferroelectric layer 318 is composed of, or otherwise includes, ScAlN. The base layer 316 may be composed of, or otherwise include, aluminum nitride (AlN) and/or another III-nitride-based material (e.g., GaN). The ferroelectric layer 318 may be single-crystalline as described herein.

In some cases, the heterostructure 312 of each waveguide core 305 may further include one or more additional layers. For instance, a (further) buffer layer may be disposed between the base layer 316 and the ferroelectric layer 318. In some cases, the further buffer layer has the same composition as the base layer (e.g., AlN). In other cases, the further buffer layer has a different composition than the base layer 316. For instance, the base layer 316 may be composed of, or otherwise include, GaN, while the buffer layer may be composed of, or otherwise include, AlN. The use of AlN may be useful to enhance optical confinement.

The positions of the signal structure 306 and the ground metal structures 308, 310 may be optimized for maximizing the applied electric field in the waveguide core 305 and minimizing any optical absorption due to the proximity of these metals to the resonator. The gap between the ring resonator 302 and the bus waveguide 307, and the width of the bus waveguide 307, may be optimized or otherwise configured for enhanced waveguide-resonator coupling and their phase-matching condition.

The device 300 may further include a cladding layer 320. In the case of FIG. 3, the cladding layer 320 is composed of, or otherwise includes, SiO₂. Additional or alternative materials may be used. For instance, in one example, an Al₂O₃ layer may be disposed between the SiO₂ layer and the ferroelectric layer 318.

The device 300 may include fewer, alternative, or additional structures, elements, or features. For instance, the signal electrode 306 and the ground metal electrodes or structures 308, 310 may include one or more structures spaced from the ring resonator 302. In the example of FIG. 3, the signal electrode 306 and the ground metal electrodes or structures 308, 310 include contact pads 322, 323, 324, respectively. The configuration and other characteristics of the signal electrode 306 and the ground metal electrodes or structures 308, 310 may vary from the example shown.

The manner in which optical signals are coupled to, and received from, the device 300 may vary. As shown in FIG. 3, part a, the device 300 may include a light source or other optical input and an optical output. In some cases, the optical input and/or the optical output is supported by the substrate 314. Each of the optical input and/or the optical output may include an optical port and/or other device coupled to the bus waveguide 307. The construction, configuration and other characteristics of the optical port(s), and the optical input and the optical output more generally, may vary. For instance, in some cases, the optical input and/or the optical output may be integrated to any desired extent with the bus waveguide 307.

Further details regarding the process of fabricating the portions of the MRM devices outside of the waveguide core can be found in Shin, W. et al., “Demonstration of green and UV wavelength high Q aluminum nitride on sapphire microring resonators integrated with microheaters,” Appl Phys Lett 2021, 118 (21), 211103, the entire disclosure of which is hereby incorporated by reference. In some cases, after defining the microring resonator, buffered HF is used to remove the two layers of the hard mask, SiO₂ and Al₂O₃. An SiO₂ layer may be deposited with plasma-enhanced chemical vapor deposition (PECVD). Alternative or additional layers may be deposited via atomic layer deposition (ALD). Then one or more metal layers (e.g., Ti, Au, and/or Al) may be directly deposited on the lateral sides of the ScAlN ring resonator as the ground metal structures, followed by PECVD SiO₂ deposition of the cladding layer. The signal metal structure (e.g., metal stack) may be sputtered on top of the SiO₂ cladding layer, underneath which the ring resonator is located. After making SiO₂ openings for via contacts, further metal stacks are evaporated as a metal via and the ground-signal-ground (GSG) contact pads. Finally, dicing and polishing to expose the waveguide facets of the optical input and optical output (e.g., optical ports) are performed.

Described below are further example photonic devices based on high-quality epitaxy of single crystalline ScAlN by plasma-assisted molecular beam epitaxy (MBE). As described below, the photonic devices exhibit a second order nonlinear optical response. The photonic devices are configured as, or include, microring resonators having a ferroelectric ScAlN layer. The photonic devices may constitute a component of an integrated quantum photonic device or system.

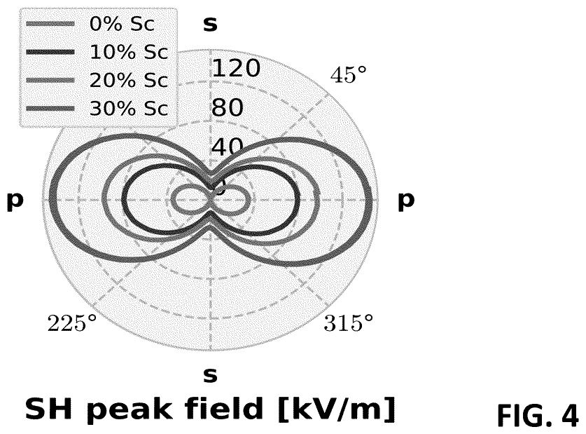

To investigate the effect of Sc doping to AlN on the enhancement of the optical nonlinearity, a series of high quality ScAlN layers with various Sc doping levels (10%, 20% and 30%) were grown on a sapphire substrate by MBE. The ScAlN layers are transparent from UV to the infrared. Subsequently, second-harmonic polarimetry was measured. The fundamental wavelength of the laser was 1266 nm. Upon focusing the laser output on the ScAlN layer, a second harmonic signal at 633 nm was generated. The polarimetry measurement characterizes the s- and p-polarized second harmonic generation transmitted from the film as a function of the first harmonic polarization. For this measurement, the peak on-axis field strength for the first harmonic pulses was 3.4 MV/cm and the detected second-harmonic is p-polarized as shown in FIG. 4. A five-times stronger signal was realized when the AlN is doped with 10% Sc, which was further boosted to 15 times when the doping level was increased to 30%. Such a strong enhancement of the second-order nonlinearity of ScAlN makes it a useful material to build high-performance quantum photonic devices.

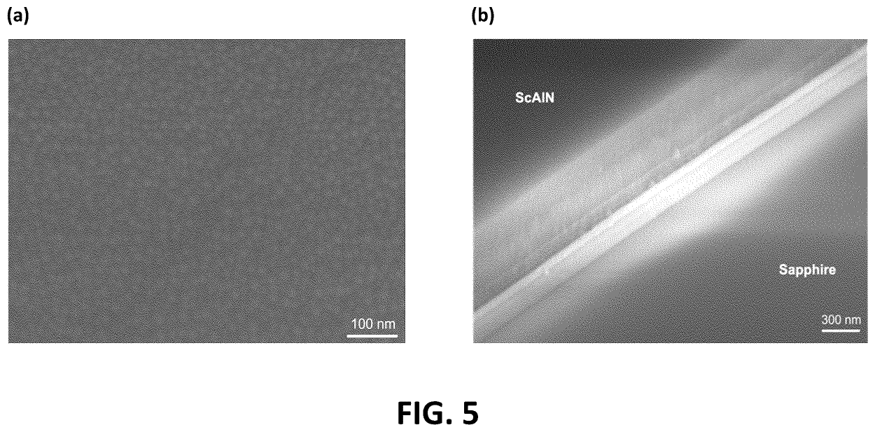

To fabricate the example microring resonator device, 500 nm ScAlN layer was grown by MBE on a AlN template on a sapphire wafer. FIG. 5, part (a), shows the surface morphology of the grown layer, characterized by the scanning electron microscope (SEM), which exhibits smooth surface and crack-free and negligible grain formation. 500 nm SiO2 was then deposited as the etching mask for the ScAlN layer. The geometry of the MRR devices was then transferred via E-beam lithography followed by Al2O3 lift-off, which was used as the etching mask for the SiO₂ layer due to the superior selectivity between Al₂O₃ and SiO₂ in a fluorine-based dry etching system. The relatively thick ScAlN layer was etched in a Cl₂/BCl₃/Ar environment with an optimized inductively coupled plasma-reactive ion etching (ICP-RIE) process to achieve a relatively vertical and smooth sidewall profile as depicted in FIG. 5, part (b). Finally, a 3 μm SiO₂ layer was deposited by plasma-enhanced chemical vapor deposition (PECVD) as a top cladding layer.

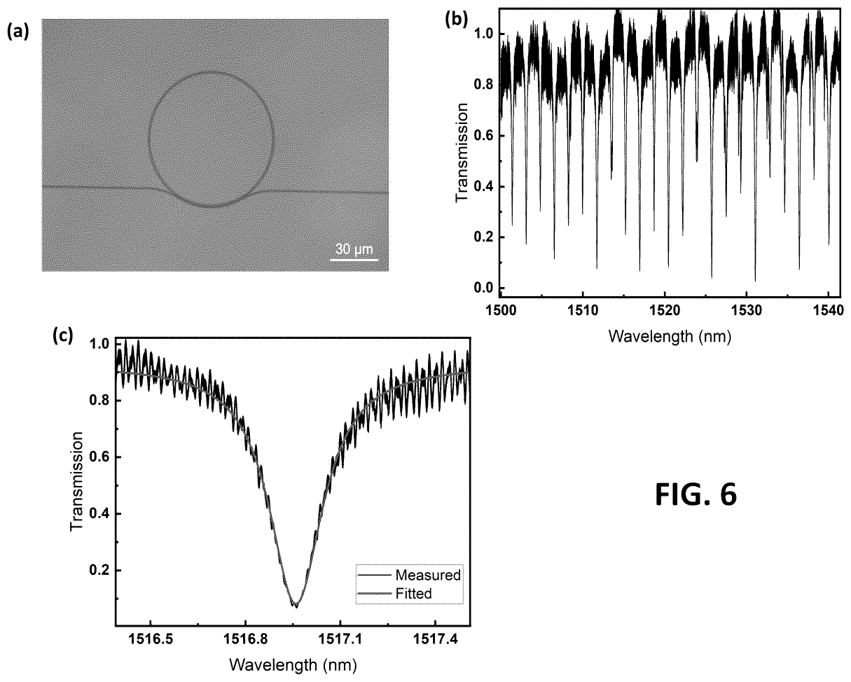

The example MRR devices were then polished on edges to form an optical input and an optical output. The optical input may be coupled to a tunable laser operating in the telecom band via lensed fiber. The light source was polarized in TE mode before coupling by adjusting a polarizer. The output signal was coupled and collected from the optical output port of the chip. For the example MRR device with a ring radius of 100 μm coupled to a bus waveguide with a 400 nm gap, as shown in FIG. 6, part (a), the transmission spectrum was measured and plotted in FIG. 6, part (b). By fitting one of the resonant peaks (FIG. 6, part (c)), an intrinsic Q-factor of 1.2×10⁴ was found, which can be further improved by optimizing or otherwise updating the device design and the fabrication process.

Described herein are examples of photonic devices having a ferroelectric ScAlN layer as an efficient nonlinear optical material. The ferroelectric ScAlN layer may be used in a variety of high performance quantum photonic devices. The ferroelectric ScAlN layer has a wide bandgap, which is tunable by varying the doping level of Sc. The ferroelectricity and piezoelectricity of the ScAlN and other III-nitride-based layers establish a platform for highly integrated photonic devices and systems.

As described above, the waveguides and other III-nitride-based structures of the disclosed devices are monocrystalline. The resulting structures (e.g., wurtzite structures) are monocrystalline to a degree not realizable via, for instance, sputtering-based procedures for forming ScₓAl₁₋ₓN layers. Such procedures are only capable of producing structures with x-ray diffraction rocking curve line widths on the order of a few degrees at best. In contrast, the structures of the disclosed devices exhibit x-ray diffraction rocking curve line widths on the order of a few hundred arc-seconds or less, well over an order of magnitude less. In this manner, leakage current paths are minimized or otherwise sufficiently reduced so that the resulting wurtzite structure has a suitably high breakdown field strength level, e.g., sufficiently greater than the ferroelectric coercive field strength.

The above-noted differences in crystal quality evidenced via x-ray diffraction rocking curve line widths may also be used to distinguish between monocrystalline and polycrystalline structures. As used herein, the term “polycrystalline” refers to structures having x-ray diffraction rocking curve line widths on the order of a few degrees or higher. As used herein, the terms “monocrystalline” and “single crystalline” (and derivatives thereof) refer to structures having x-ray diffraction rocking curve line widths at least one order of magnitude lower than the order of a few degrees.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A photonic device comprising:
a substrate; and
a waveguide supported by the substrate;
wherein:
the waveguide comprises a III-nitride-based layer; and
the III-nitride-based layer is ferroelectric.

2. The photonic device of claim 1, wherein the III-nitride-based layer is single-crystalline.

3. The photonic device of claim 1, wherein the waveguide comprises a buffer layer disposed between the III-nitride-based layer and the substrate.

4. The photonic device of claim 3, wherein the buffer layer comprises a III-nitride-based material.

5. The photonic device of claim 4, wherein the III-nitride-based material is AlN.

6. The photonic device of claim 1, wherein the waveguide is configured as a resonator.

7. The photonic device of claim 1, wherein the waveguide is configured as a ring resonator.

8. The photonic device of claim 1, wherein the waveguide is configured as a bus waveguide.

9. The photonic device of claim 1, wherein the waveguide is configured for second harmonic generation.

10. The photonic device of claim 1, wherein the III-nitride-based layer comprises ScAlN.

11. The photonic device of claim 1, further comprising an electrode spaced from the waveguide to apply an electric field to the waveguide.

12. The photonic device of claim 1, wherein the substrate comprises sapphire.

13. The photonic device of claim 1, wherein:
an optical input supported by the substrate;
an optical output supported by the substrate; and
the waveguide is disposed between the optical input and the optical output.

14. A photonic device comprising:
a substrate; and
a heterostructure supported by the substrate;
wherein:
the heterostructure comprises a III-nitride-based waveguide; and
the III-nitride-based waveguide comprises a ferroelectric layer.

15. The photonic device of claim 14, wherein the ferroelectric layer is single-crystalline.

16. The photonic device of claim 14, wherein the heterostructure further comprises a buffer layer disposed between the ferroelectric layer and the substrate.

17. The photonic device of claim 16, wherein the buffer layer comprises a III-nitride-based material.

18. The photonic device of claim 17, wherein the III-nitride-based material is AlN.

19. The photonic device of claim 14, wherein the III-nitride-based waveguide is configured as a resonator.

20. The photonic device of claim 14, wherein the III-nitride-based waveguide is configured as a ring resonator.

21. The photonic device of claim 14, wherein the III-nitride-based waveguide is configured as a bus waveguide.

22. The photonic device of claim 14, wherein the III-nitride-based waveguide is configured for second harmonic generation.

23. The photonic device of claim 14, wherein the ferroelectric layer comprises ScAlN.

24. The photonic device of claim 14, further comprising an electrode spaced from the III-nitride-based waveguide to apply an electric field to the III-nitride-based waveguide.

25. A microring resonator device comprising:
a substrate;
a bus waveguide supported by the substrate; and
a ring waveguide supported by the substrate and spaced from the bus waveguide;
wherein:
the ring waveguide comprises a III-nitride-based layer; and
the III-nitride-based layer is ferroelectric.

26. The microring resonator device of claim 25, wherein the III-nitride-based layer is single- crystalline.
